(19) United States
(12) Patent Application Publication
(10) Pub. No.: US 2007/0030198 A1
(43) Pub. Date: Feb. 8, 2007

(54) Multifrequency H-shaped antenna

(75) Inventor: Shen-Pin Wei, Hsichih (TW)

Correspondence Address: LOWE HAUPTMAN BERNER, LLP, 1700 DIAGONAL ROAD, SUITE 300, ALEXANDRIA, VA, 22314, US

(73) Assignee: WISTRON NEWEB CORP., Hsichih (TW)

(21) Appl. No.: 11/281,404

(22) Filed: Nov. 18, 2005

(30) Foreign Application Priority Data
Aug. 8, 2005 (TW) 94213473

(51) Int. Cl. H01Q 1/38

(52) U.S. Cl. 343/700 MS; 343/702

(57) ABSTRACT

A multifrequency H-shape antenna is disclosed herein. The multifrequency H-shape antenna includes a conductive radiating element, a conductive grounding element, a conductive interconnecting element, and a coaxial cable. The conductive radiating element includes a left end, a right end, and a T construction. The conductive interconnecting element includes a first part, a second part, and a third part. The conductive interconnecting element is connected between the conductive radiating element and the conductive grounding element. The coaxial cable is electrically connected to the feeding point of the conductive interconnecting element. By using the improved construction described above, the wireless bandwidth can be increased.

### BACKGROUND OF THE INVENTION

1. Field of the Invention

The present invention generally relates to an antenna, and more particularly to a multifrequency H-shape antenna.

2. Description of the Prior Art

In these years, wireless communication technologies are prevailing, and the devices built inside with a wireless communication antenna are widespread. In this fast change era, for example, the notebook computers with wireless communication function are prevailing increasingly, and the need for compact notebook computers increases gradually. Cooperating with the design of structure, the wireless communication antenna should be shrunk into the limited space.

FIG. 1 illustrates a conventional Planar Inverted-F Antenna 10 (PIFA) including a rectangular conductive radiating element 12, a rectangular conductive grounding element 13, a conductive signal feeding point 14, and a conductive grounding leg 15. The conductive radiating element 12 has opposite left and right ends. The conductive signal feeding point 14 is electrically connected to a coaxial cable 16. The conductive grounding leg 15 is electrically connected between the conductive grounding element 13 and the conductive radiating element 12. The drawback of the antenna of this type is that it can transmit and receive only in a single frequency band.

FIG. 2 illustrates an improved construction of a conventional multifrequency inverted-F antenna 20. The antenna includes: a rectangular radiating element 220 having opposite left and right ends; a rectangular conductive grounding element 230 that is vertically spaced apart from the conductive radiating element 220; a conductive interconnecting element 240 extending between the conductive radiating element 220 and the conductive grounding element 230 and including first, second, and third parts 242, 244, 246, the first part 242 being electrically connected to the conductive radiating element 220, the second part 244 being electrically connected to the conductive grounding element 230, the third part 246 electrically interconnecting between the first and second parts 242, 244; and a feeding point (P) lying between the first part 242 and the third part 246 connected to a coaxial cable 250.

As shown in FIG. 2, the length (A) measured from the left end of the conductive radiating element 220 to the first part 242 of the conductive interconnecting element 240 is different from the length (B) measured from the right end of the conductive radiating element 220 to the first part 242 of the conductive interconnecting element 240. Accordingly, they correspond respectively to two different frequency bands. The length (A) corresponds to a low frequency band, whose bandwidth is about 200 MHz (Voltage Standing Wave Ratio (VSWR)<2), and the length (B) corresponds to a high frequency band, whose bandwidth is about 2300 MHz (VSWR<2.5). In order to meet higher specifications in the future, there is a need for an improved construction of the multifrequency antennas that are capable of achieving a wider bandwidth both in low and high frequency bands.

### SUMMARY OF THE INVENTION

The object of this invention is to achieve a wider bandwidth of the antenna by using the improved construction of the multifrequency antenna, and further to achieve a widest bandwidth under the finite increment of volume.

In view of the foregoing, the present invention provides a multifrequency H-shape antenna, including a conductive radiating element, a conductive grounding element, a conductive interconnecting element, and a coaxial cable. The conductive radiating element includes a left end and a right end, and a T construction. The conductive interconnecting element includes a first part, a second part, and a third part. The conductive interconnecting element is respectively connected to the conductive radiating element and the conductive grounding element. The coaxial cable is electrically connected to the conductive interconnecting element at a feeding point.

### BRIEF DESCRIPTION OF THE DRAWINGS

FIG. 1 shows a top view of a conventional inverted-F antenna.

FIG. 2 shows a top view of a conventional multifrequency inverted-F antenna.

FIG. 3 shows a top view of the multifrequency H-shape antenna according to one preferred embodiment of the present invention.

FIG. 4 shows a perspective view of the multifrequency H-shape antenna according to another preferred embodiment of the present invention.

FIG. 5 shows a perspective view of the multifrequency H-shape antenna according to a further preferred embodiment of the present invention.

FIG. 6 shows a chart of test results of a multifrequency inverted-F antenna and a multifrequency H-shape antenna.

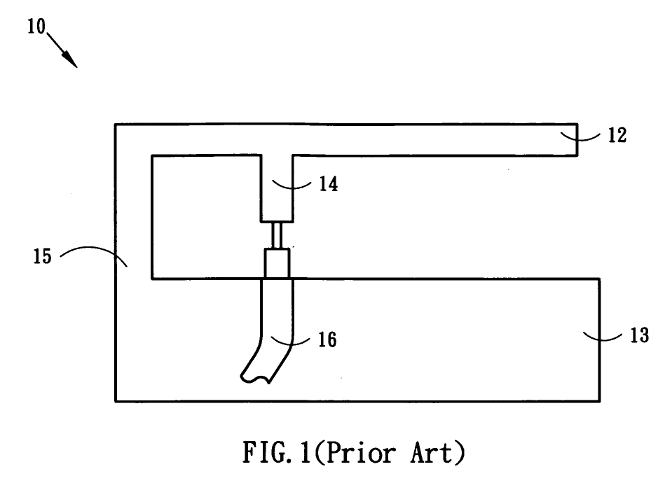

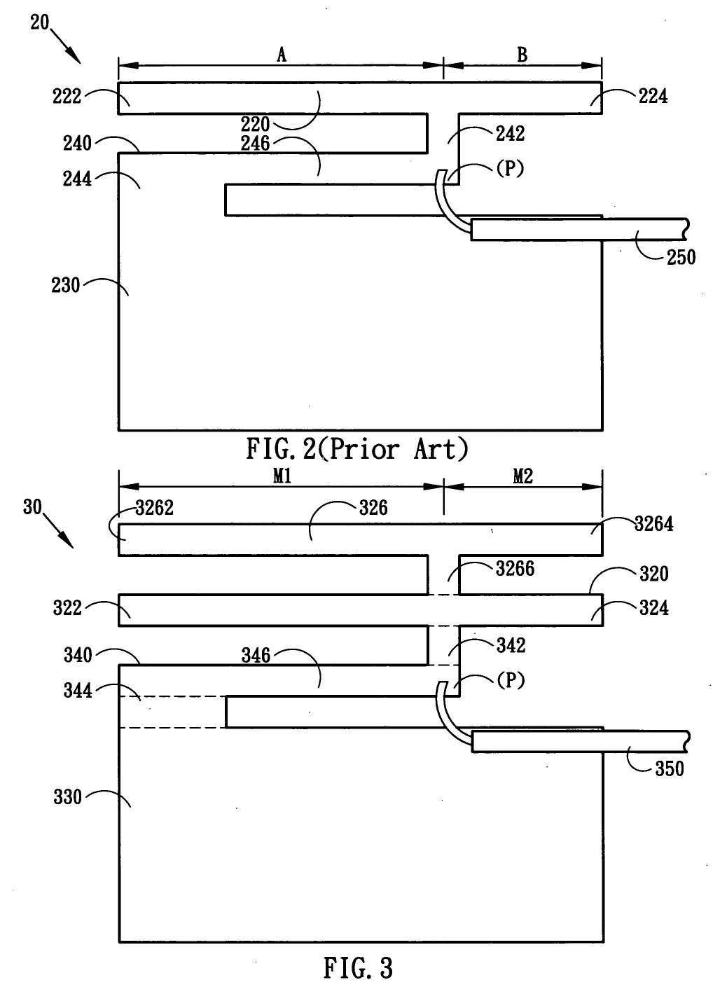

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

FIG. 3 illustrates a preferred embodiment of a multifrequency H-shape antenna of this invention. The antenna includes: a conductive radiating element 320 in the form of a wire that extends in a longitudinal direction and that has opposite left end 322 and right end 324, and a T construction 326 connected to the conductive radiating element 320, the T construction 326 lying on top of the left end 322 and right end 324 to achieve a wider bandwidth of the antenna, the T construction 326 having opposite left end 3262 and right end 3264, and a transmission line 3266; a conductive grounding element 330 vertically spaced apart from the conductive radiating element 320; a conductive interconnecting element 340 extending between the conductive element 320 and the conductive grounding element 330 and including a first part 342, a second part 344, and a third part 346, the first part 342 and the second part 344 respectively and vertically extending to the conductive radiating element 320 and the conductive grounding element 330, the first part 342 being electrically connected to the conductive radiating element 320, the second part 344 being electrically connected to the conductive grounding element 330, the third part 346 electrically interconnecting between the first and second parts 342, 344; and a coaxial cable 350 electrically connected to the conductive interconnecting element 340 at a feeding point P.

The transmission line 3266 divides the conductive radiating element 320 into left and right sections with lengths M1 and M2 respectively, wherein the left section includes the left end 322 of the conductive radiating element 320 and the left end 3262 of the T construction 326, and the right section includes the right end 324 of the conductive radiating element 320 and the right end 3264 of the T construction 326. The length M1 is measured from the left end 322 of the conductive radiating element 320 to the transmission line 3266, and the length M2 is measured from the right end 324 of the conductive radiating element 320 to the transmission line 3266. The left and right sections of the conductive radiating element 320 correspond respectively to a low frequency band and a high frequency band. As is known to skilled artisans, when the electromagnetic wave is emitted from an antenna, the length of the antenna should be at least a quarter of the wavelength of the electromagnetic wave. If the frequency of the electromagnetic wave of the signal is pretty low, the height of the antenna for transmitting signals should be several tens of kilometers. Accordingly, a high frequency band corresponds to a shorter antenna length, and a low frequency band corresponds to a longer antenna length.

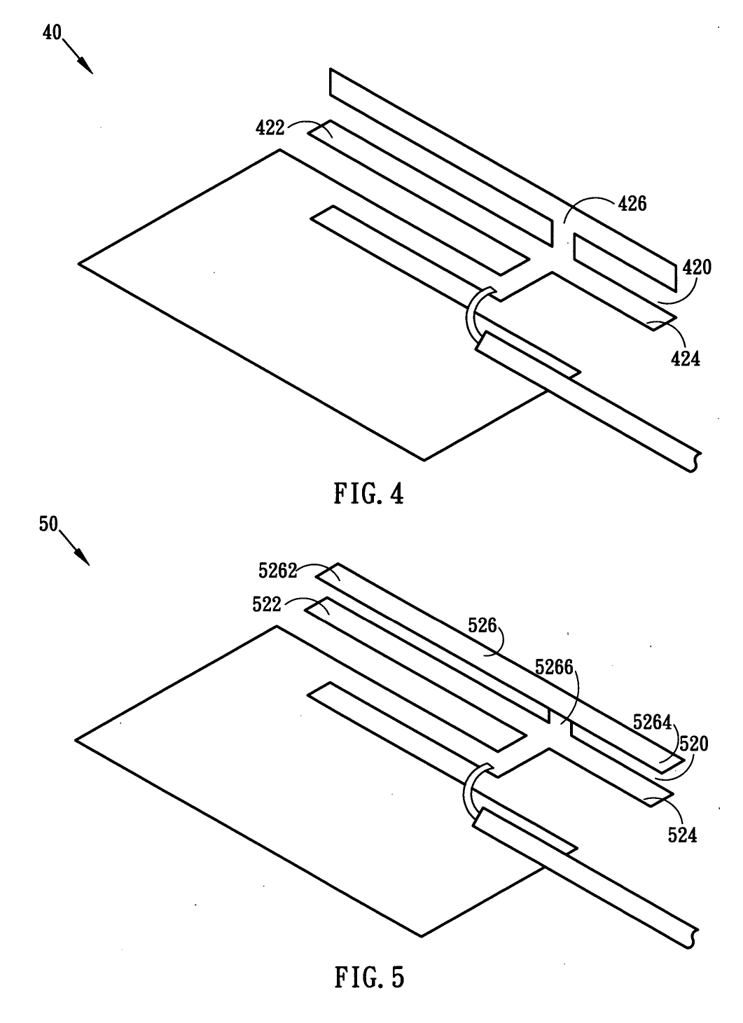

FIG. 4 illustrates another preferred embodiment of the multifrequency H-shape antenna 40 of this invention, a derivative of the antenna shown in FIG. 3. According to this embodiment, the plane of the T construction 426 of the conductive radiating element 420 and the plane of the left end 422 and the right end 424 of the conductive radiating element 420 form an angle about 90 degrees. This type of the multifrequency H antenna also can achieve a wider bandwidth.

FIG. 5 illustrates a further preferred embodiment of the multifrequency H-shape antenna 50 of this invention, another derivative of the antenna shown in FIG. 3. According to this embodiment, the plane of the T construction 526 of the conductive radiating element 520 and the plane of the left end 522 and the right end 524 of the conductive radiating element 520 form an angle about 90 degrees, and the plane of the left end 5262 and the right end 5264 of the T construction 526 and the plane of the transmission line 5266 of the T construction 526 further form an angle about 90 degrees.

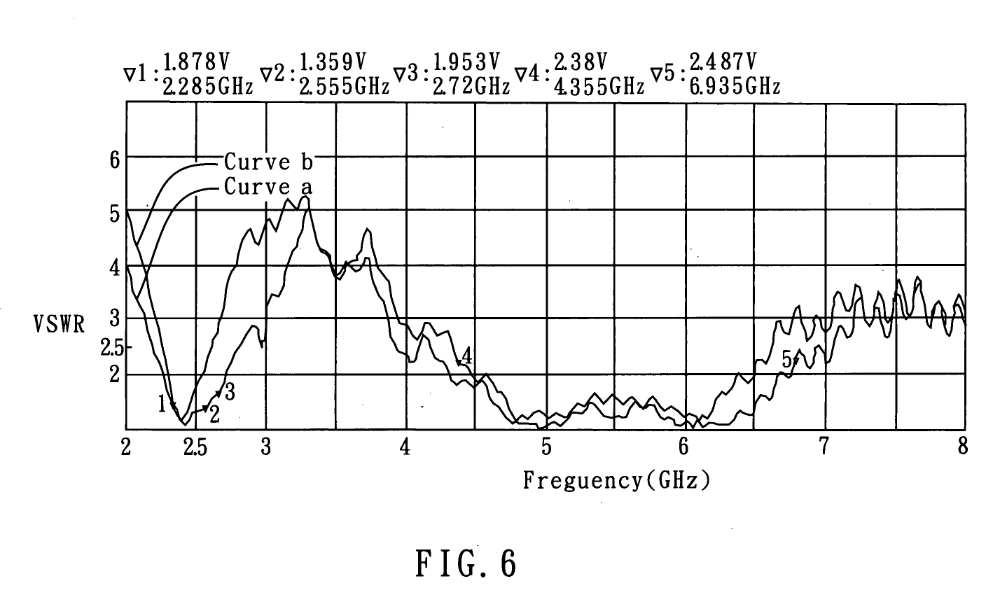

FIG. 6 shows a chart of test results of the conventional multifrequency inverted-F antenna and the multifrequency H-shape antenna of this invention by measuring the Voltage Standing Wave Ratio (VSWR). The ideal value of VSWR is 1, which means no reflected power. The greater the value of VSWR is, the higher the reflected power is, and the more return loss is. Curve a is a test result of a multifrequency H-shape antenna, and Curve b is that of a multifrequency inverted-F antenna. With regard to antennas in notebook computers, the bandwidth in low frequency band, 2400 MHz, (VSWR<2) is about 100 MHz, and the bandwidth in high frequency band, 5 GHz, (VSWR<2.5) is about 1000 MHz. Regarding the multifrequency inverted-F antenna, the bandwidth in low frequency band is about 200 MHz, and that in high frequency band is about 2300 MHz. However, regarding the multifrequency H-shape antenna of this invention, the bandwidth in low frequency band is about 440 MHz, and that in high frequency band is about 2600 MHz. Consequently, the multifrequency H antenna of this invention can achieve a wider bandwidth both in low and high frequency bands.

According to the multifrequency H-shape antenna of this invention, the conductive radiating element is in the form of electronic circuits. The antenna can be installed in wireless electronic devices, such as notebook computers or Personal Digital Assistants (PDA). The material of the multifrequency H-shape antenna can be a flexible material, such as aluminum foil or copper foil.

Although specific embodiments have been illustrated and described, it will be appreciated by those skilled in the art that various modifications may be made without departing from the scope of the present invention, which is intended to be limited solely by the appended claims.

What is claimed is:

1. A multifrequency H-shape antenna, comprising:
a conductive radiating element with a rectangular section and a T construction, wherein both of them jointly form a H-shape construction; and
a conductive grounding element; and
a conductive interconnecting element extending between said conductive radiating element and said conductive grounding element and including first, second, and third parts, said first parts being connected to said rectangular section, said second part being connected to said conductive grounding element, said third part interconnecting between said first part and said second part; and
a coaxial cable electrically connected to said conductive interconnecting element at a feeding point.

2. The multifrequency antenna according to claim 1, wherein said T construction is located on top of said rectangular section.

3. The multifrequency antenna according to claim 2, wherein said T construction includes a left end, a right end and a transmission line.

4. The multifrequency antenna according to claim 1, wherein said conductive radiating element is divided by transmission line into two sections corresponding respectively to a low frequency band and a high frequency band.

5. The multifrequency antenna according to claim 1, wherein said first and second parts of said conductive interconnecting element respectively and vertically extends to said conductive radiating element and said conductive grounding element.

6. The multifrequency antenna according to claim 1, wherein material of said conductive radiating element, said conductive interconnecting element and said conductive grounding element is flexible metal.

7. The multifrequency antenna according to claim 1, wherein material of said conductive radiating element, said conductive interconnecting element and said conductive grounding element is aluminum foil.

8. The multifrequency antenna according to claim 1, wherein material of said conductive radiating element, said conductive interconnecting element and said conductive grounding element is copper foil.

9. The multifrequency antenna according to claim 3, wherein said T construction of said conductive radiating element defines a plane which is approximately perpendicular to another plane defined by said rectangular section of said conductive radiating element.

10. The multifrequency antenna according to claim 3, wherein said left and right ends of said T construction defines a plane which is approximately perpendicular to another plane defined by said transmission line of said T construction.
